(19) United States
(12) Patent Application Publication
(10) Pub. No.: US 2015/0097751 A1
(43) Pub. Date: Apr. 9, 2015

(54) PLANAR ARRAY ANTENNA STRUCTURE

(71) Applicant: TECOM Co., LTD., Hsin-Chu (TW)

(72) Inventors: Wen-Hsien HSU, Hsin-Chu (TW); Wen-Hsiu HSU, Hsin-Chu (TW); Chung-Hsuan WEN, Hsin-Chu (TW); Shang-Chun CHAO, Hsin-Chu (TW)

(73) Assignee: TECOM Co., LTD., Hsin-Chu (TW)

(21) Appl. No.: 14/046,348

(22) Filed: Oct. 4, 2013

(51) Int. Cl. H01Q 21/28

(52) U.S. Cl. CPC H01Q 21/28
USPC 343/844; 343/893; 343/848

(57) ABSTRACT

A planar array antenna structure includes a substrate, an array antenna, and a bottom ground portion. The substrate has a front surface and a rear surface. The array antenna is composed of a plurality of antenna units and disposed on the front surface of the substrate in a symmetrical and polygonal arrangement. A spaced slot is formed between every two antenna units. The bottom ground portion is polygonal and arranged on the rear surface of the substrate. The bottom ground portion has a plurality of included angles thereon, and one notch is formed between two included angles and the notches are correspondingly arranged to the spaced slots. Accordingly, the planar array antenna structure is used to generate high-gain radiation variations, effectively restrain the isolation between the radiators, and significantly increase overall performance of the antenna.

### BACKGROUND

1. Technical Field

The present disclosure relates generally to an antenna, and more particularly to a planar array antenna structure is operated at 5 to 6 GHz.

2. Description of Prior Art

In antenna communication, multi-input and multi-output, or MIMO is the use of multiple antennas at both the transmitter and receiver to improve communication performance. That is, spatial multiplexing and multiple antennas are adopted to transmit and receive multiple data streams through the same frequency channel. The MIMO is applied to. the wireless LAN (WLAN) system to increase data rate of IEEE 802.11a or 802.11G by using two transmitting antennas.

In order to implement the MIMO antenna wireless communication system, the array antenna structure is adopted. TW patent No. M441940 discloses an array structure to provide multiple antenna radiators with same shape by the sheet metal stamping technology. Further, at least three antenna radiators are arranged to stand on a surface of a substrate in a symmetrical and polygonal arrangement, thus increasing antenna directivity, directive gain, and improving communication quality.

Although the three-dimensional shaped array antenna structure can obtain the above-mentioned advantages, the occupied space should not be underestimated when the three-dimensional shaped array antenna structure is installed inside a communication device. Further, it is inconvenient to operate the communication device because of a reserved installation space inside the communication device. In addition, the array antenna structure is manufactured by sheet metal stamping multiple antenna radiators and then the antenna radiators are stood on the substrate, thus increasing manufacturing costs and time.

### SUMMARY

An object of the present disclosure is to provide a planar array antenna structure to solve the above-mentioned problems. Accordingly, a plurality of antenna units are disposed on the substrate in a symmetrical and polygonal arrangement so as to generate high-gain radiation variations, effectively restrain the isolation between the radiators, and significantly increase overall performance of the antenna.

Another object of the present disclosure is to provide a planar array antenna structure to flatly arrange the antenna radiator on the substrate so as to reduce height of the array antenna structure, easily to manufacture the array antenna structure, reduce manufacturing costs, save space inside the communication device installing the array antenna structure, and conveniently operate the communication device.

In order to achieve the above-mentioned objects, the planar array antenna structure comprising:

a substrate having a front surface and a rear surface; and

an array antenna composed of a plurality of antenna units and disposed on the front surface of the substrate;

wherein the antenna units are disposed on the front surface of the substrate in a symmetrical and polygonal arrangement, and a spaced slot is formed between every two antenna units;

wherein the polygonal arrangement is a triangular arrangement, a quadrilateral arrangement, a pentagonal arrangement, a hexagonal arrangement, a heptagonal arrangement, or an octagonal arrangement;

wherein each antenna unit has a top ground portion, a main radiator, and an auxiliary radiator;

wherein the top ground portion is trapezoidal and has an upper edge and a lower edge;

wherein the main radiator is rectangular or square, and the main radiator having a signal feed point is arranged at left of the lower edge of the top ground portion; the signal feed point is electrically connected to the lower edge of the top ground portion;

wherein the auxiliary radiator is arranged at right of the lower edge of the top ground portion and electrically connected to the lower edge;

wherein the auxiliary radiator is L-shaped;

wherein the bottom ground portion is disposed on the rear surface of the substrate and corresponding to the antenna units disposed on the front surface of the substrate;

wherein the bottom ground portion is polygonal, such as triangular, quadrilateral, pentagonal, hexagonal, heptagonal, or octagonal; the bottom ground portion has a plurality of included angles thereon, and a notch is formed between two included angles and the notches are correspondingly arranged to the spaced slots formed on the front surfaces of the substrate;

wherein each notch is rectangular and configured to generate a resonance current; a length of each notch is a quarter of the wavelength;

wherein between the main radiator and the auxiliary radiator, a spacing is arranged in a half of the wavelength to increase bandwidth and provide better impedance matching;

wherein between the auxiliary radiator and a main radiator of another adjacent antenna unit, a spacing is arranged in a quarter of the wavelength to provide better isolation;

wherein each spaced slot formed between the antenna units is a quarter of the wavelength in length to generate a resonance current and provide better isolated ground;

wherein the spaced slots and the notches are configured to generate an optimum resonance current to restrain the current generated from adjacent main radiators and auxiliary radiators to achieve the best isolation;

wherein the frequency band of the resonance current is designed according to length of the spaced slots and the notches;

wherein the bottom ground portion disposed on the rear surface is not conductive to the top ground portion disposed on the front surface;

wherein the area of the bottom ground portion is less than the area of the top ground portion to control the resonance frequency generated by the spaced slots formed on the front surfaces and the notches formed on the rear surfaces, thus achieving the best isolation from adjacent antennas;

wherein the planar array antenna structure has a gain which is greater than or equal to 2 dBi;

wherein the planar array antenna structure has a return loss which is greater than or equal to 10 dB;

wherein the planar array antenna structure has an isolation which is greater than or equal to 20 dB.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a schematic front view of a planar array antenna structure according to the present disclosure;

FIG. 2 is a schematic rear view of the planar array antenna structure according to the present disclosure;

FIG. 3 is a schematic view of a substrate of the planar array antenna structure according to the present disclosure;

FIG. 4 is a schematic curve chart showing return loss vs. frequency of different antenna units using the planar array antenna structure according to the present disclosure;

FIG. 5 is a schematic curve chart showing isolation vs. frequency of different antenna units using the planar array antenna structure according to the present disclosure;

FIG. 6 is a schematic view of another planar array antenna structure according to the present disclosure;

FIG. 7 is a schematic curve chart showing return loss vs. frequency of different antenna units using the planar array antenna structure in FIG. 6;

FIG. 8 is a schematic curve chart showing isolation vs. frequency of different antenna units using the planar array antenna structure in FIG. 6;

FIG. 9 is a schematic view of further another planar array antenna structure according to the present disclosure;

FIG. 10 is a schematic curve chart showing return loss vs. frequency of different antenna units using the planar array antenna structure in FIG. 9;

FIG. 11 is a schematic curve chart showing isolation vs. frequency of different antenna units using the planar array antenna structure in FIG. 9;

FIG. 12 is a schematic view of further another planar array antenna structure according to the present disclosure;

FIG. 13 is a schematic curve chart showing return loss vs. frequency of different antenna units using the planar array antenna structure in FIG. 12;

FIG. 14 is a schematic curve chart showing isolation vs. frequency of different antenna units using the planar array antenna structure in FIG. 12;

FIG. 15 is a schematic view of a radiation pattern in the x-z plane of a single antenna according to the planar array antenna structure of the present disclosure;

FIG. 16 is a schematic view of a radiation pattern in the y-z plane of a single antenna according to the planar array antenna structure of the present disclosure; and

FIG. 17 is a schematic view of a radiation pattern in the x-y plane of a single antenna according to the planar array antenna structure of the present disclosure.

### DETAILED DESCRIPTION

Reference will now be made to the drawing figures to describe the present invention in detail.

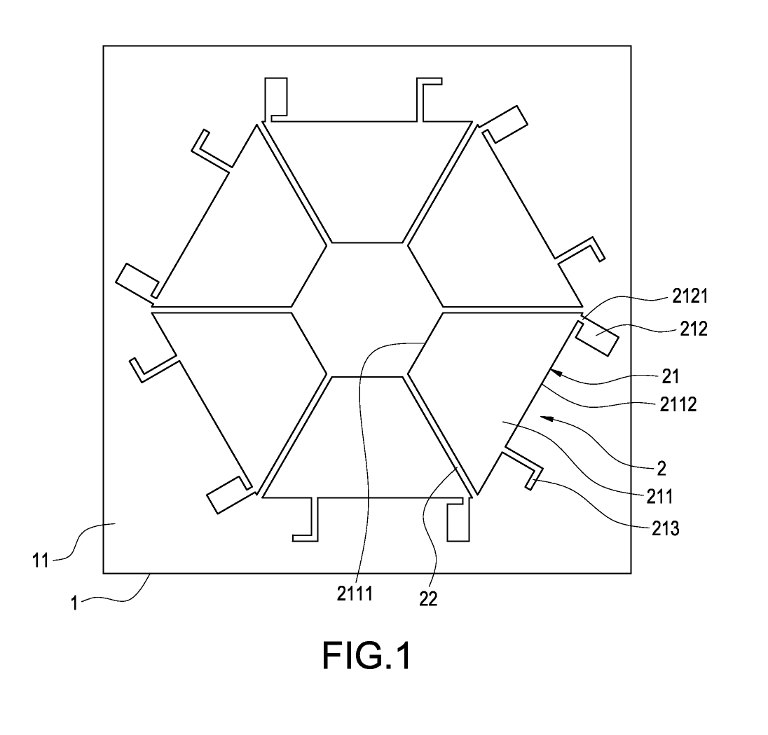

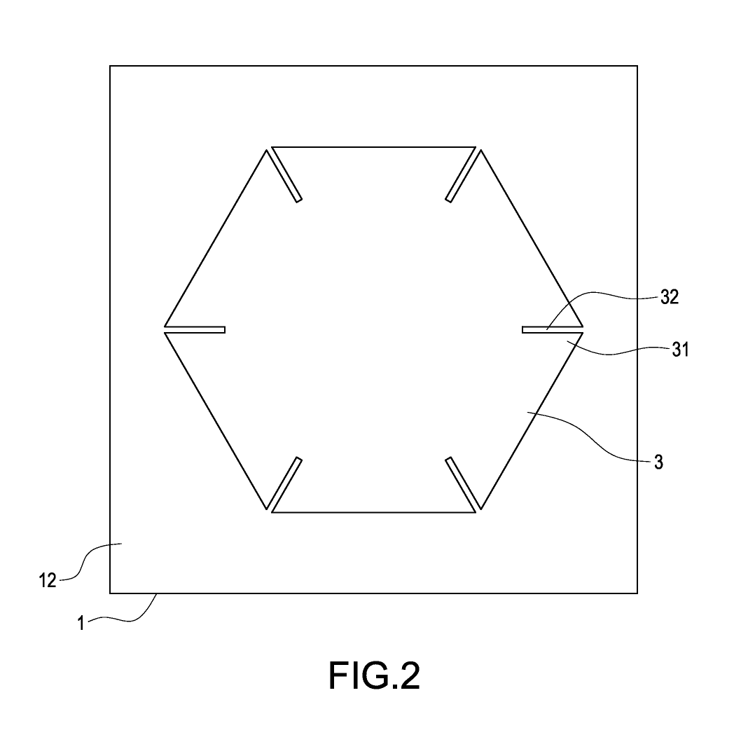

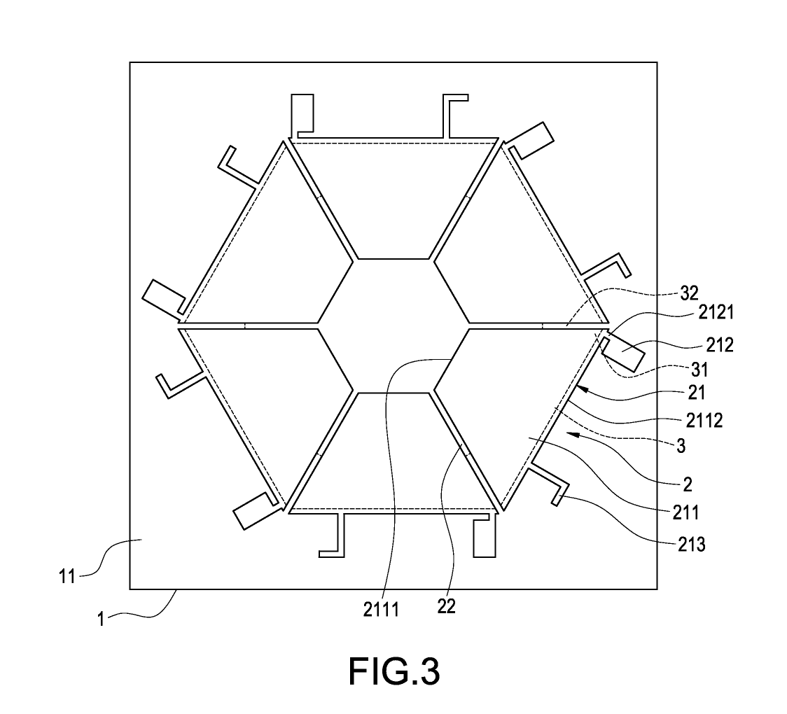

Reference is made to FIG. 1, FIG. 2, and FIG. 3 which are a schematic front view, a schematic rear view, and a schematic view of a substrate of a planar array antenna structure according to the present disclosure. The planar array antenna structure includes a substrate 1, an array antenna 2, and a bottom ground portion 3.

The substrate 1 has a front surface 11 and a rear surface 12. In particular, the substrate I is a polyester fiberglass board.

The array antenna 2 is composed of a plurality of antenna units 21 and disposed on the front surface 11 of the substrate 1, and the antenna units 21 are disposed on the front surface 11 of the substrate 1 in a symmetrical and polygonal arrangement. Also, a spaced slot 22 is formed between every two antenna units 21. Each antenna unit 21 includes a top ground portion 211, a main radiator 212, and an auxiliary radiator 213. The top ground portion 211 is trapezoidal and has an upper edge 2111 and a lower edge 2112. The main radiator 212 is rectangular or square, and the main radiator 212 has a signal feed point 2121 is arranged at left of the lower edge 2112 of the top ground portion 211, and the signal feed point 2121 is electrically connected to the lower edge 2112 of the top ground portion 211. The auxiliary radiator 213 is inverted L-shaped and arranged at right of the lower edge 2112 of the top ground portion 211 and electrically connected to the lower edge 2112. For convenience, the number of the antenna units 21 is six exemplified for further demonstration, but not limited. In particular, the polygonal arrangement is a triangular arrangement, a quadrilateral arrangement, a pentagonal arrangement, a hexagonal arrangement, a heptagonal arrangement, or an octagonal arrangement.

The bottom ground portion 3 is disposed on the rear surface 12 of the substrate 1 and corresponding to the antenna units 21 disposed on the front surface 11 of the substrate 1. In particular, the bottom ground portion 3 is not conductive to the antenna units 21 disposed on the front surface 11. The bottom ground portion 3 is polygonal, such as triangular, quadrilateral, pentagonal, hexagonal, heptagonal, or octagonal. The bottom ground portion 3 has a plurality of included angles 31 thereon, and one notch 32 is formed between two included angles 31 and the notches 32 are correspondingly arranged to the spaced slots 22 formed on the front surfaces 11 of the substrate 1. In this embodiment, the notches 32 are rectangular.

Between the main radiator 212 and the auxiliary radiator 213, a spacing is arranged in a half of the wavelength (permittivity of air is equal to 1) to increase bandwidth and provide better impedance matching.

In addition, between the auxiliary radiator 213 and a main radiator 212 of another adjacent antenna unit 21, a spacing is arranged in a quarter of the wavelength (permittivity of air is equal to 1) to provide better isolation.

Each spaced slot 22 formed between the front surfaces 11 of the substrate 1 and the antenna units 21 is a quarter of the wavelength (permittivity of air is equal to 1) in length. The spaced slots 22 generate a resonance current and provide better isolated ground. The central resonance frequency is located at 6.15 GHz.

Each notch 32 formed on the rear surfaces 12 of the substrate 1 is a quarter of the wavelength (permittivity of FR4 is equal to 4.3) in length. The notches 32 generate a resonance current. The central resonance frequency is located at 3.3 GHz and the double frequency is located at 6.5 GHz.

The spaced slots 22 and the notches 32 are provided to generate an optimum resonance current to restrain the current generated from adjacent main radiators and auxiliary radiators, thus achieving the best isolation. In particular, the frequency band of the resonance current is designed according to length of the spaced slots 22 and the notches 32.

In addition, the bottom ground portion 3 disposed on the rear surface 12 is not conductive to the top ground portion 211 disposed on the front surface 11. Also, an area of the bottom ground portion 3 is less than that of the top ground portion 211 so as to control the resonance frequency generated by the spaced slots 22 formed on the front surfaces 11 and the notches 32 formed on the rear surfaces 12, thus achieving the best isolation from adjacent antennas.

Accordingly, the antenna performance specifications of the planar array antenna structure of the present disclosure are: (1) the gain is greater than or equal to 2 dBi; (2) the return loss is greater than or equal to 10 dB; and (3) the isolation is greater than or equal to 20 dB, Because the signals transmitted from the radiators of the antenna is operated via the IEEE 802.11 a/n/ac, the planar array antenna structure can generate high-gain radiation variations, effectively restrain the isolation between the main radiators and the auxiliary radiators, and significantly increase overall performance of the antenna.

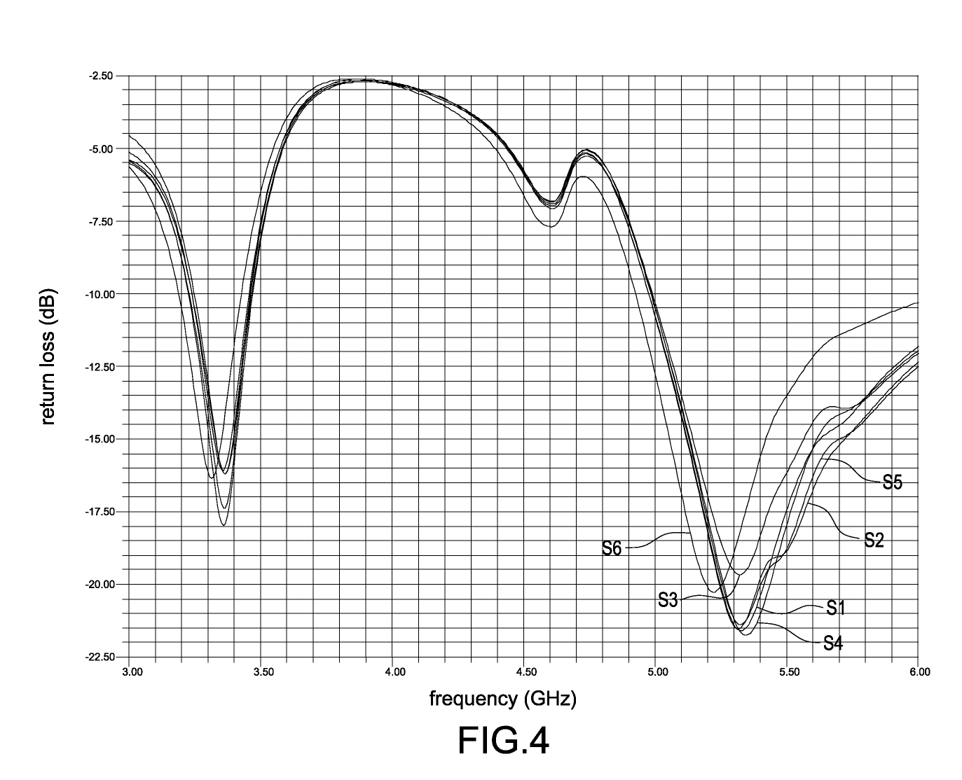

Reference is made to FIG. 4 which is a schematic curve chart showing return loss vs. frequency of different antenna units using the planar array antenna structure according to the present disclosure.

1. The return loss of the first antenna unit shown in curve s1 at 5.33 GHz is −21.6 dB;

2. The return loss of the second antenna unit shown in curve s2 at 5.31 GHz is −21.5 dB;

3. The return loss of the third antenna unit shown in curve s3 at 5.32 GHz is −19.7 dB;

4. The return loss of the fourth antenna unit shown in curve s4 at 5.34 GHz is −21.7 dB;

5. The return loss of the fifth antenna unit shown in curve s5 at 5.32 GHz is −21.4 dB; and

6. The return loss of the sixth antenna unit shown in curve s6 at 5.23 GHz is −20.25 dB.

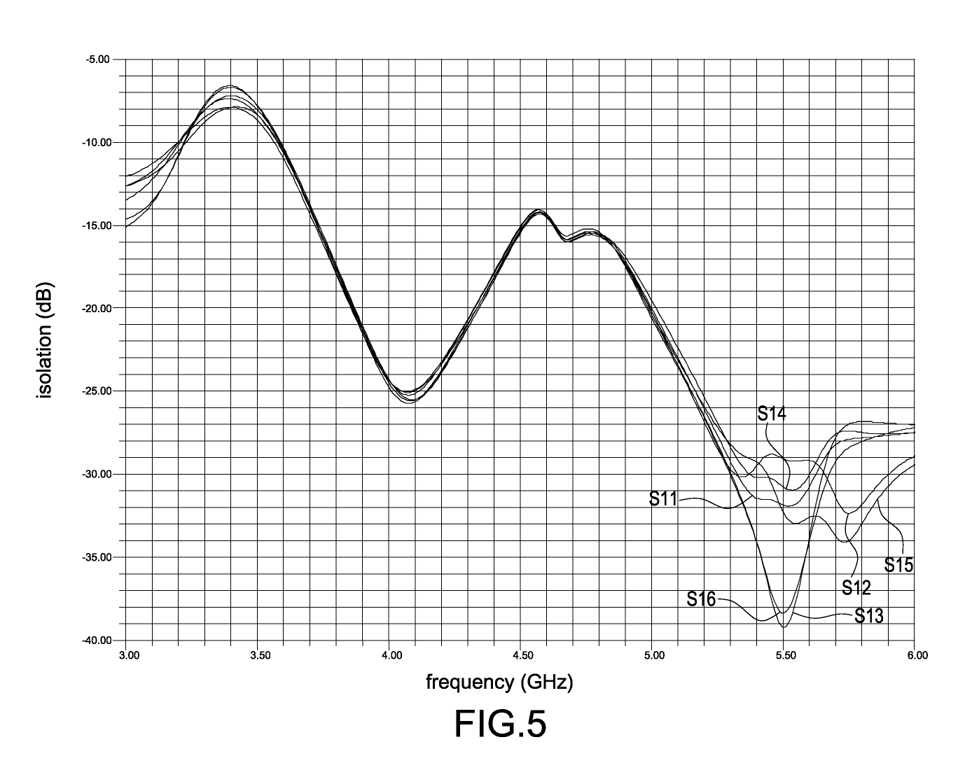

Reference is made to FIG. 5 which is a schematic curve chart showing isolation vs. frequency of different antenna units using the planar array antenna structure according to the present disclosure.

1. The isolation of the first antenna unit shown in curve s11 at 5.52 GHz is −32 dB;

2. The isolation of the second antenna unit shown in curve s12 at 5.75 GHz is −32.2 dB;

3. The isolation of the third antenna unit shown in curve s13 at 5.50 GHz is −39.2 dB;

4. The isolation of the fourth antenna unit shown in curve s14 at 5.52 GHz is −31 dB;

5. The isolation of the fifth antenna unit shown in curve s15 at 5.72 GHz is −34.1 dB; and

6. The isolation of the sixth antenna unit shown in curve s16 at 5.50 GHz is −38.2 dB.

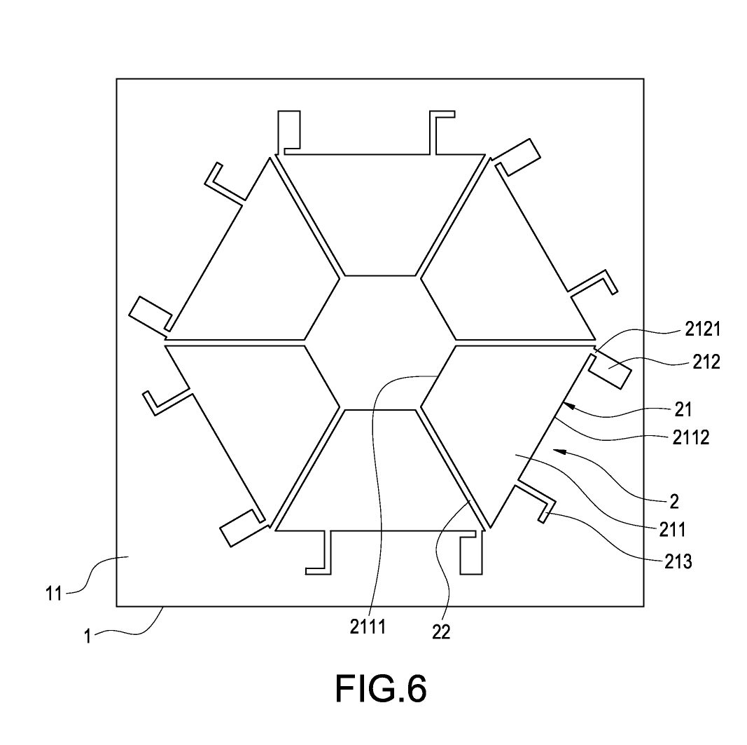

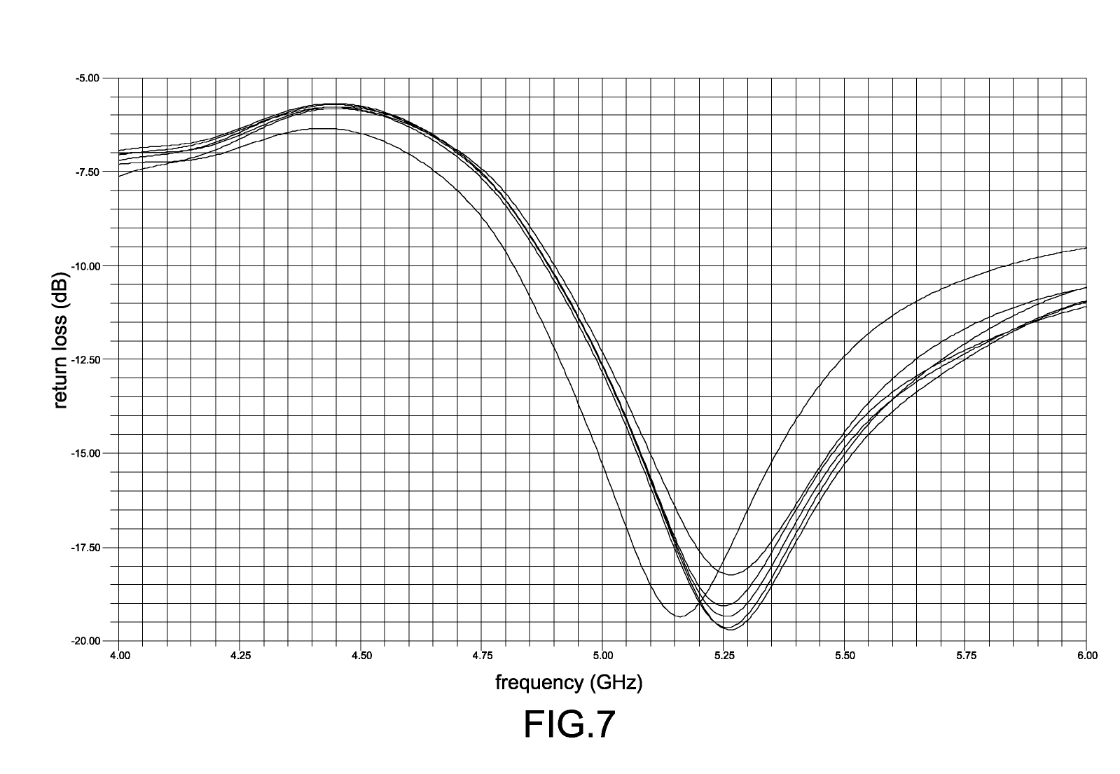

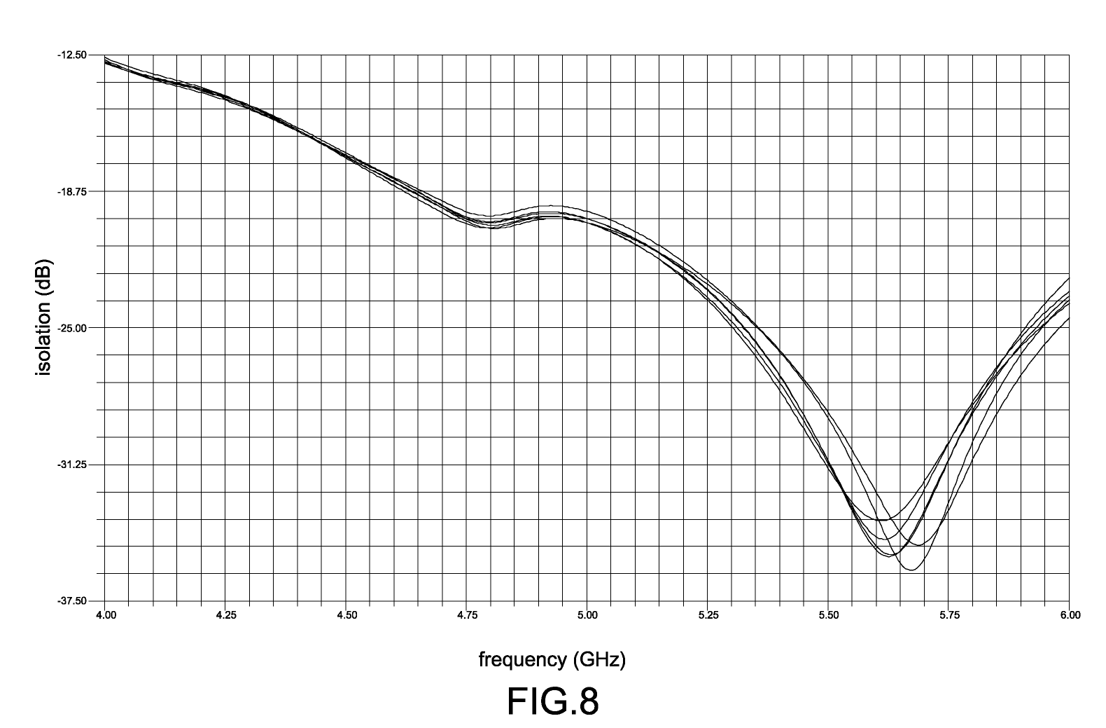

Reference is made to FIG. 6 which is a schematic view of another planar array antenna structure according to the present disclosure; and reference is made to FIG. 7 and FIG. 8 which are schematic curve charts showing return loss vs. frequency and isolation vs. frequency of different antenna units using the planar array antenna structure in FIG. 6, respectively. The major difference between this embodiment and the above-mentioned embodiments shown in FIG. 1 to FIG. 3 is that the absence of the bottom ground portion 3 disposed on the rear surface in this embodiment. Therefore, the return loss is worse about 5 dB as shown in FIG. 7 because of the absence of the bottom ground portion 3.

In addition, the isolation is also worse about 5 dB as shown in FIG. 8 because of the absence of the bottom ground portion 3. Although the return loss and the isolation are worse, the antenna performance specifications are still meet the following requirements: (1) the gain is greater than or equal to 2 dBi; (2) the return loss is greater than or equal to 10 dB; and (3) the isolation is greater than or equal to 20 dB.

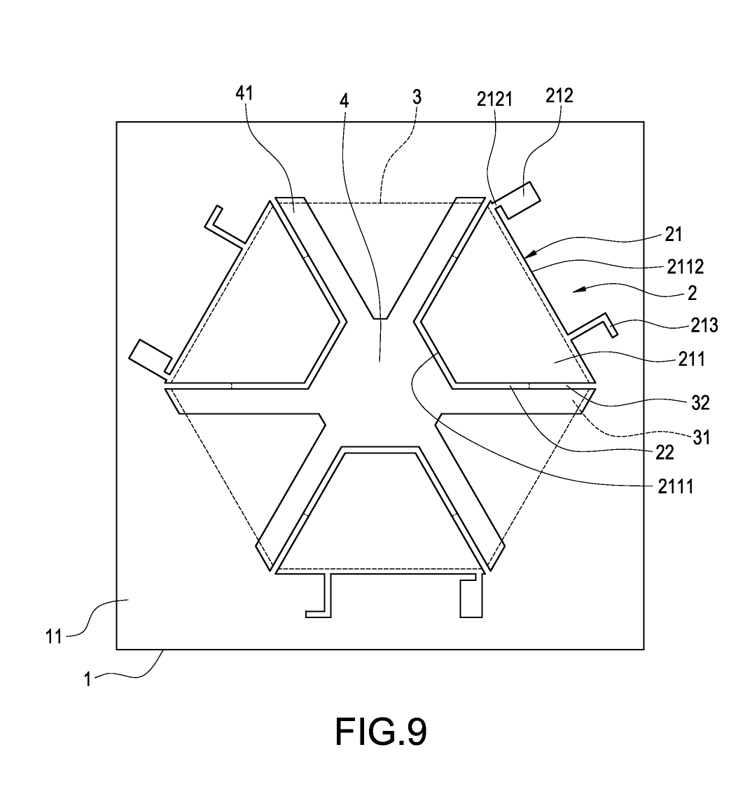

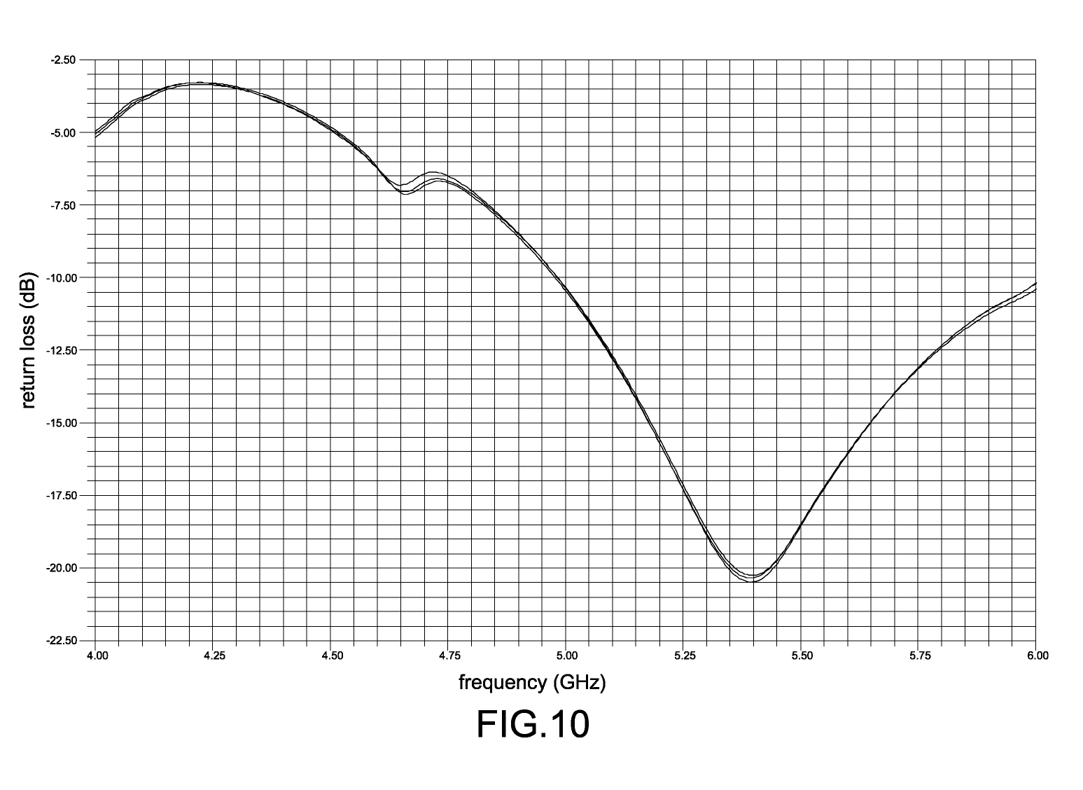

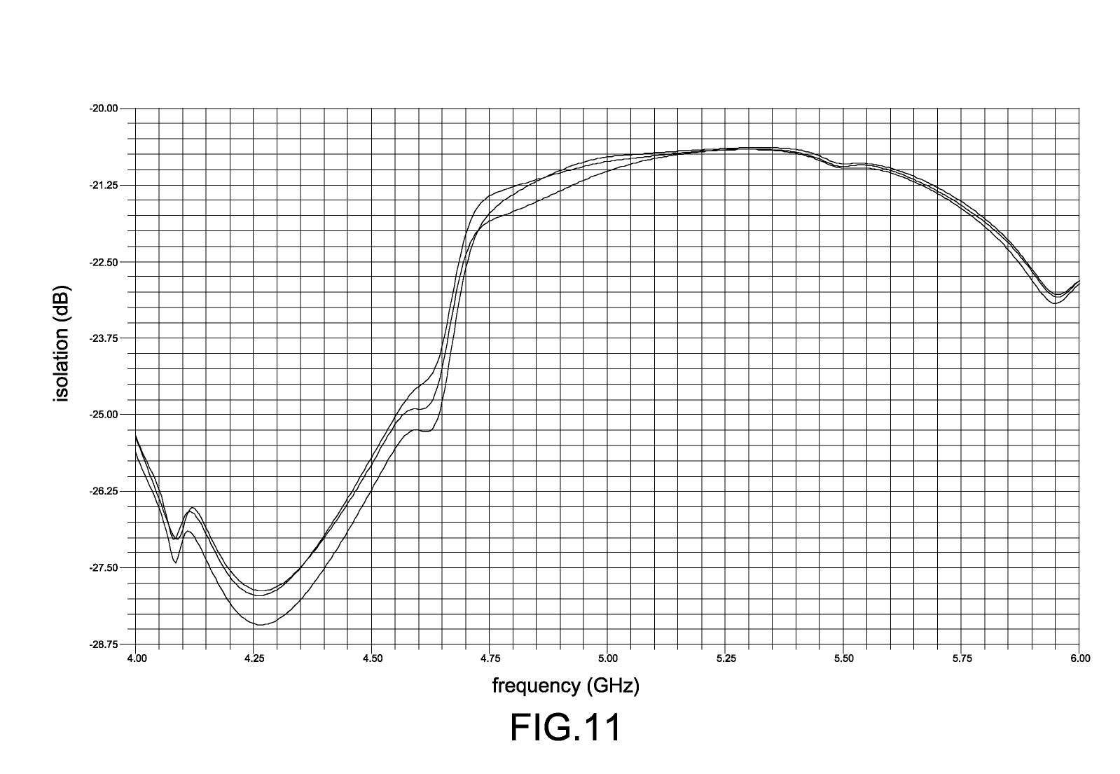

Reference is made to FIG. 9 which is a schematic view of further another planar array antenna structure according to the present disclosure; and reference is made to FIG. 10 and FIG. 11 which are schematic curve charts showing return loss vs. frequency and isolation vs. frequency of different antenna units using the planar array antenna structure in FIG. 9, respectively. The major difference between this embodiment and the above-mentioned embodiments shown in FIG. 1 to FIG. 3 is that there are three sets of symmetrical antenna units 21 are disposed on the front surface 11 of the substrate 1 in this embodiment. Also, the substrate 1 has to be designed as hexagonal. In addition, a hexagonal central ground portion 4 is arranged among the three sets of symmetrical antenna units 21. Each edge of the antenna units 21 extends to form a plurality of radial line segments 41, and a spaced slot 22 is arranged between the line segment 41 and the top ground portion 211 of the antenna unit 21.

Similarly, the antenna performance specifications are still meet the following requirements: (1) the gain is greater than or equal to 2 dBi; (2) the return loss is greater than or equal to 10 dB; and (3) the isolation is greater than or equal to 20 dB.

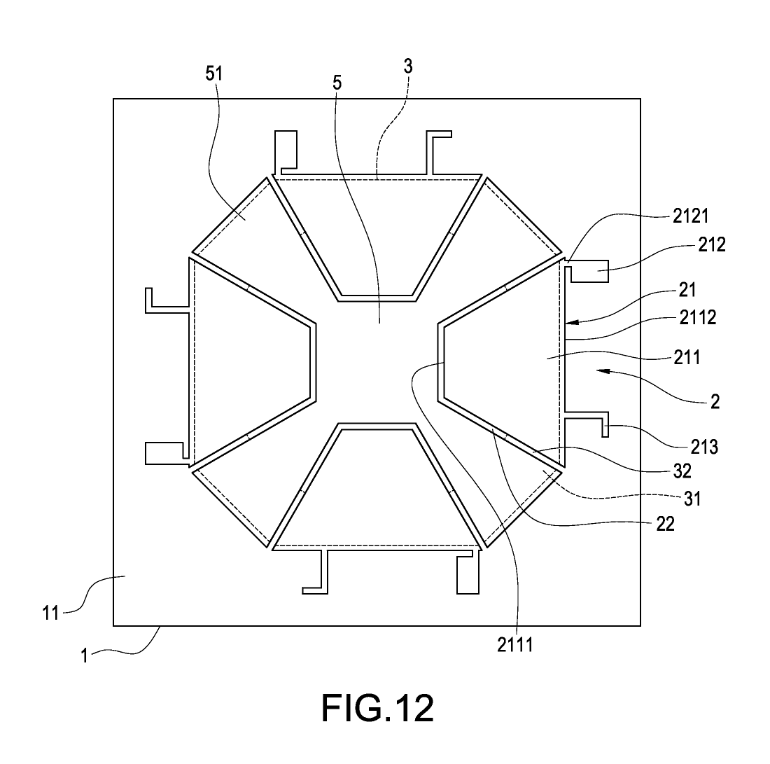

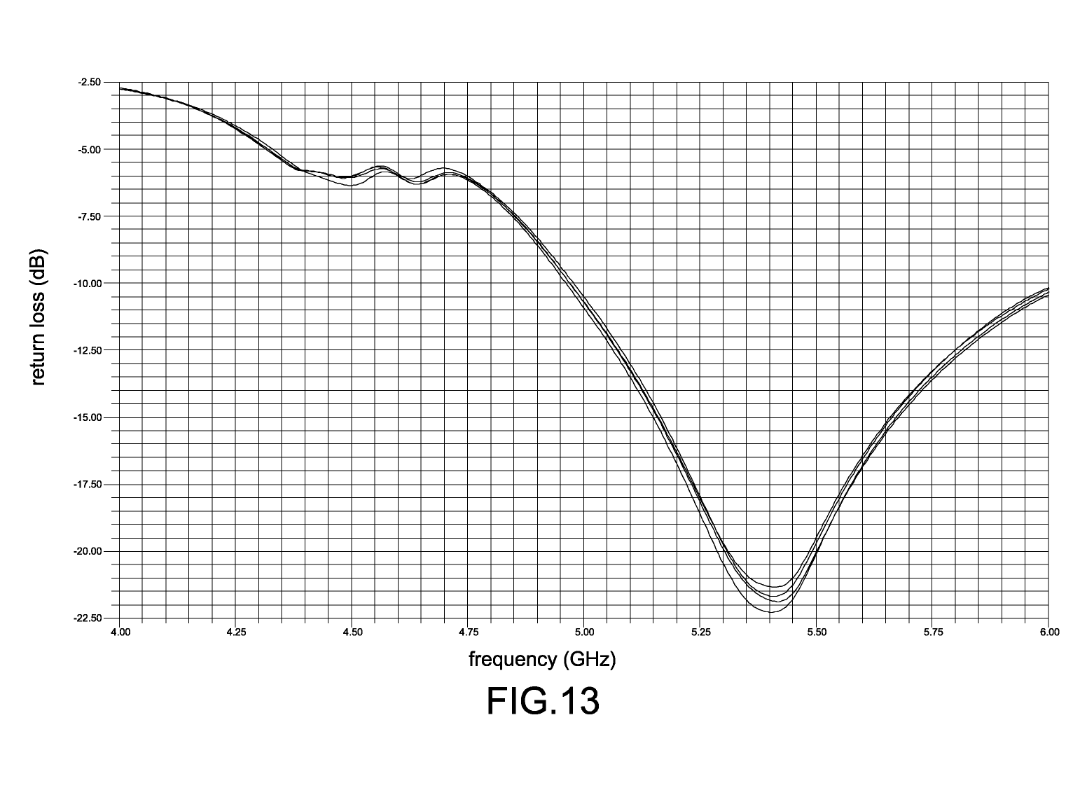

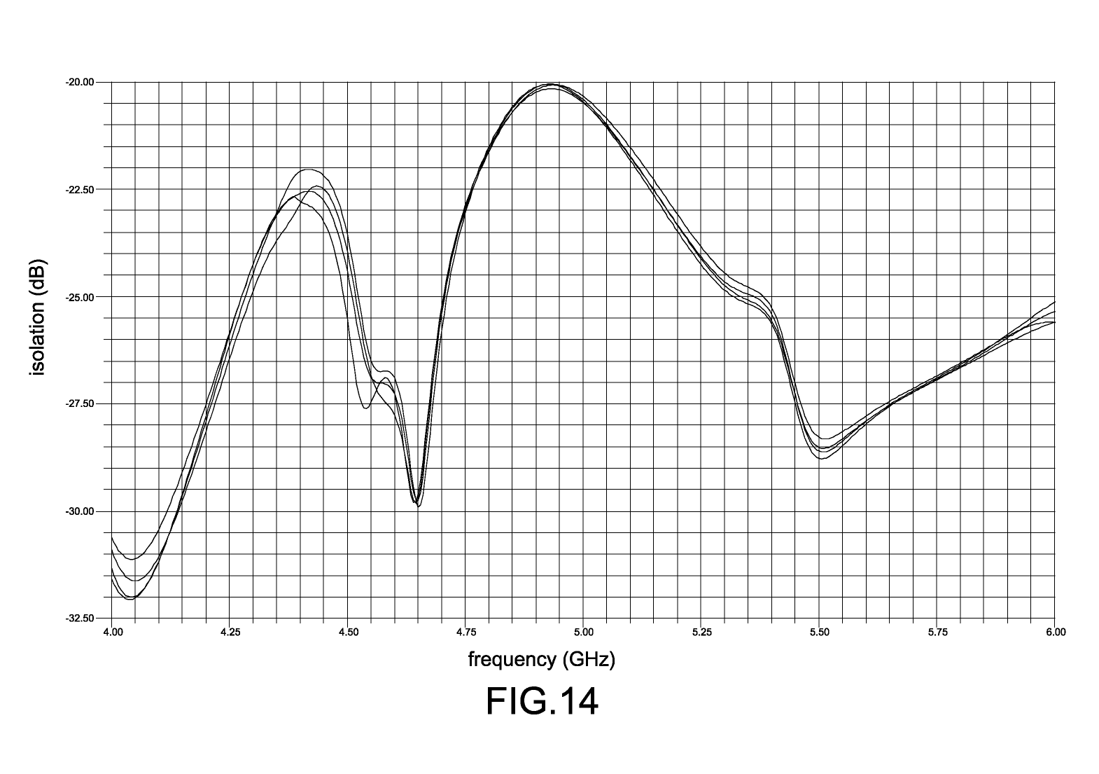

Reference is made to FIG. 12 which is a schematic view of further another planar array antenna structure according to the present disclosure; and reference is made to FIG. 13 and FIG. 14 which are schematic curve charts showing return loss vs. frequency and isolation vs. frequency of different antenna units using the planar array antenna structure in FIG. 12, respectively. The major difference between this embodiment and the above-mentioned embodiments shown in FIG. 1 to FIG. 3 is that there are four sets of symmetrical antenna units 21 are disposed on the front surface 11 of the substrate 1 in this embodiment. Also, the substrate 1 has to be designed as octagonal. In addition, a quadrilateral central ground portion 5 is arranged among the four sets of symmetrical antenna units 21. Each edge of the antenna units 21 extends to form a plurality of trapezoidal line segments 51, and a spaced slot 22 is arranged between the line segment 51 and the top ground portion 211 of the antenna unit 21.

Similarly, the antenna performance specifications are still meet the following requirements: (1) the gain is greater than or equal to 2 dBi; (2) the return loss is greater than or equal to 10 dB; and (3) the isolation is greater than or equal to 20 dB.

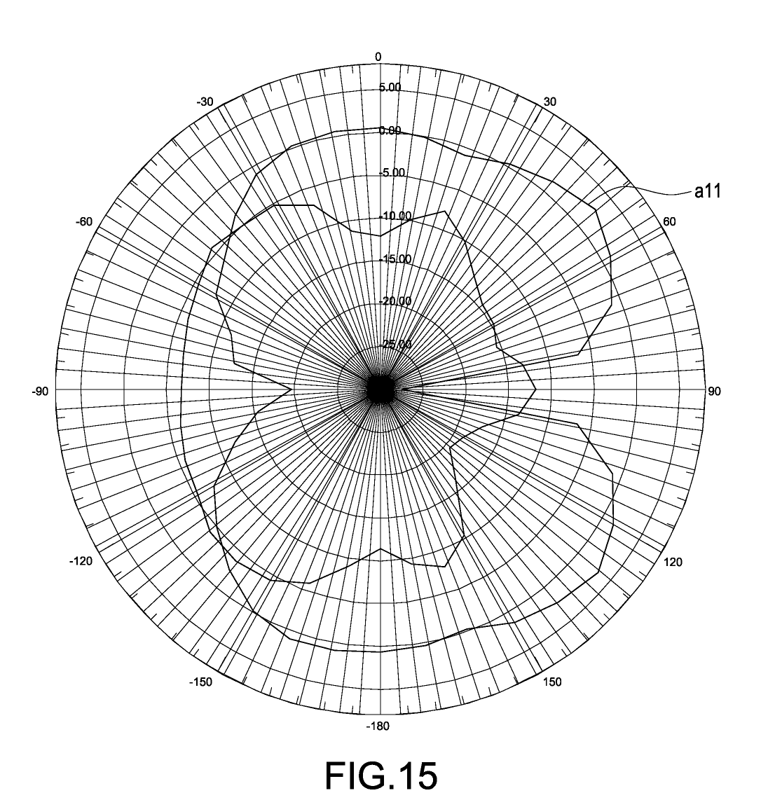

Reference is made to FIG. 15 which is a schematic view of a radiation pattern in the x-z plane of a single antenna according to the planar array antenna structure of the present disclosure.

The maximum gain of the antenna unit shown in curve a11 at 5.15 GHz in the x-z plane and phi=0° is 2.7 dBi.

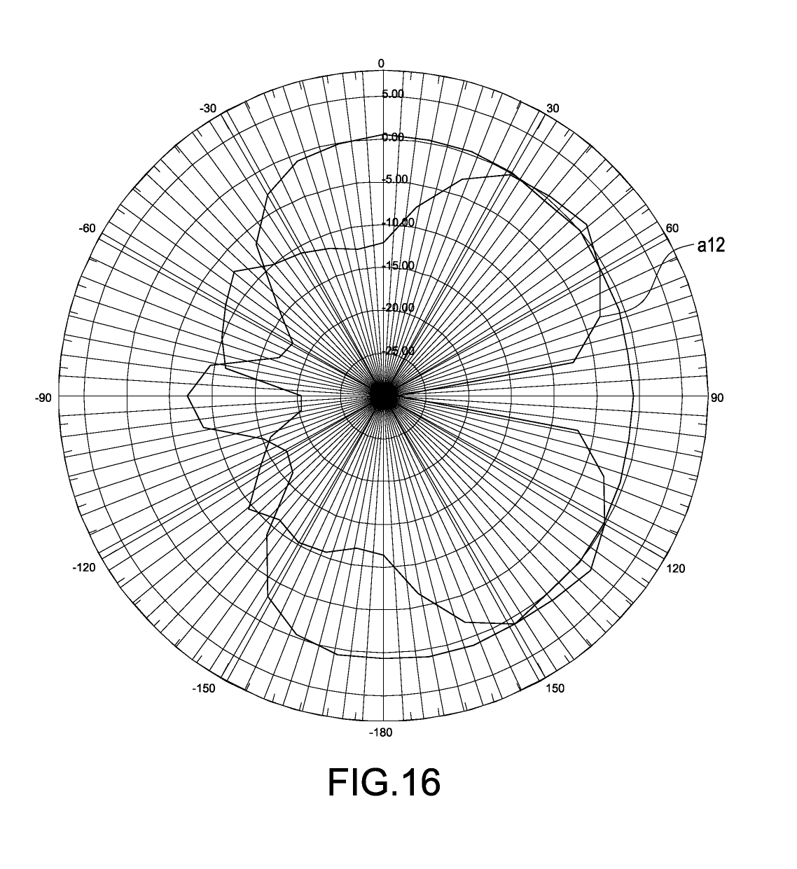

Reference is made to FIG. 16 which is a schematic view of a radiation pattern in the y-z plane of a single antenna according to the planar array antenna structure of the present disclosure.

The maximum gain of the antenna unit shown in curve a12 at 5.15 GHz in the y-z plane and phi=90° is 2.0 dBi.

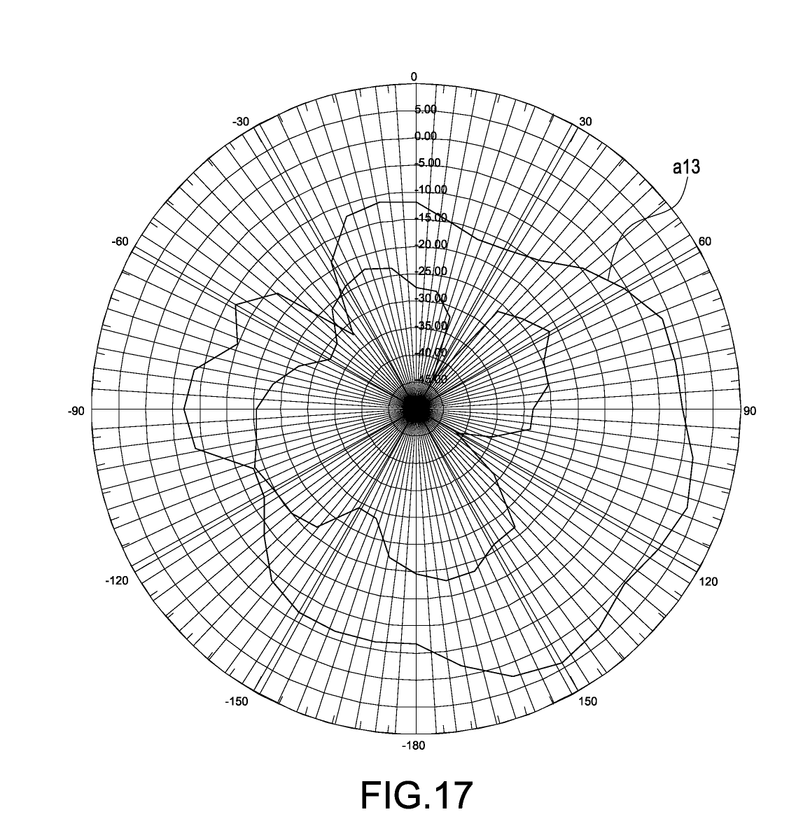

Reference is made to FIG. 17 which is a schematic view of a radiation pattern in the x-y plane of a single antenna according to the planar array antenna structure of the present disclosure.

The maximum gain of the antenna unit shown in curve a13 at 5.15 GHz in the x-y plane and theta=90° is 4.0 dBi.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is

1. A planar array antenna structure comprising:
a substrate having a front surface and a rear surface; and
an array antenna composed of a plurality of antenna units and disposed on the front surface of the substrate;
wherein the antenna units are disposed on the front surface of the substrate in a symmetrical and polygonal arrangement, and a spaced slot is formed between every o antenna units.

2. The planar array antenna structure in claim 1, wherein the polygonal arrangement is a triangular arrangement, a quadrilateral arrangement, a pentagonal arrangement, a hexagonal arrangement, a heptagonal arrangement, or an octagonal arrangement.

3. The planar array antenna structure in claim 2, wherein each antenna unit has atop ground portion, a main radiator, and an auxiliary radiator.

4. The planar array antenna structure in claim 3, wherein the top ground portion is trapezoidal and has an upper edge and a lower edge.

5. The planar array antenna structure in claim 4, wherein the main radiator is rectangular or square, and the main radiator having a signal feed point is arranged at left of the lower edge of the top ground portion; the signal feed point is electrically connected to the lower edge of the top ground portion.

6. The planar array antenna structure in claim 5, wherein the auxiliary radiator is arranged at right of the lower edge of the top ground portion and electrically connected to the lower edge.

7. The planar array antenna structure in claim 6, wherein the auxiliary radiator is L-shaped.

8. The planar array antenna structure in claim 7, further comprising:
a bottom ground portion disposed on the rear surface of the substrate and corresponding to the antenna units disposed on the front surface of the substrate.

9. The planar array antenna structure in claim 8, wherein the bottom ground portion is polygonal, such as triangular, quadrilateral, pentagonal, hexagonal, heptagonal, or octagonal; the bottom ground portion has a plurality of included angles thereon, and a notch is formed between two included angles and the notches are correspondingly arranged to the spaced slots formed on the front surfaces of the substrate.

10. The planar array antenna structure in claim 9, wherein each notch is rectangular and configured to generate a resonance current; a length of each notch is a quarter of the wavelength.

11. The planar array antenna structure in claim 10, wherein between the main radiator and the auxiliary radiator, a spacing is arranged in a half of the wavelength to increase bandwidth and provide better impedance matching.

12. The planar array antenna structure in claim 11, wherein between the auxiliary radiator and a main radiator of another adjacent antenna unit, a spacing is arranged in a quarter of the wavelength to provide better isolation.

13. The planar array antenna structure in claim 12, wherein each spaced slot formed between the antenna units is a quarter of the wavelength in length to generate a resonance current and provide better isolated ground.

14. The planar array antenna structure in claim 13, wherein the spaced slots and the notches are configured to generate an optimum resonance current to restrain the current generated from adjacent main radiators and auxiliary radiators to achieve the best isolation.

15. The planar array antenna structure in claim 14, wherein the frequency band of the resonance current is designed according to length of the spaced slots and the notches.

16. The planar array antenna structure in claim 15, wherein the bottom ground portion disposed on the rear surface is not conductive to the top ground portion disposed on the front surface.

17. The planar array antenna structure in claim 16, wherein the area of the bottom ground portion is less than the area of the top ground portion to control the resonance frequency generated by the spaced slots formed on the front surfaces and the notches formed on the rear surfaces, thus achieving the best isolation from adjacent antennas.

18. The planar array antenna structure in claim 17, wherein the planar array antenna structure has a gain which is greater than or equal to 2 dBi.

19. The planar array antenna structure in claim 18, wherein the planar array antenna structure has a gain which is greater that or equal to 10 dB.

20. The planar array antenna structure in claim 19, wherein the planar array antenna structure has an isolation which is greater than or equal to 20 dB.
